(19) United States
(12) Patent Application Publication
(10) Pub. No.: US 2004/0065684 A1
(43) Pub. Date: Apr. 8, 2004

(54) Water dispenser

(76) Inventors: John C. Cooke, San Antonio, TX (US); John W. Eddy, Riverside, CA (US); Marcel E. Crettet IV, San Antonio, TX (US); Jeffrey L. Harlan, Corona, CA (US)

Correspondence Address: LAW OFFICES OF CHRISTOPHER L. MAKAY, 1634 Milam Building, 115 East Travis Street, San Antonio, TX, 78205, US

(21) Appl. No.: 10/265,916

(22) Filed: Oct. 7, 2002

(51) Int. Cl. B67D 5/62

(52) U.S. Cl. 222/146.6; 222/105

(57) ABSTRACT

A water dispenser includes a housing and a dispense valve mounted to the housing. The water dispenser further includes a removable reservoir disposed within the housing. The removable reservoir connects to the dispense valve to deliver water thereto. Upon removal from the housing, the removable reservoir is disposable. The housing is adapted to support a water container that delivers water into the removable reservoir.

### BACKGROUND OF THE INVENTION

1. Field of the Invention

The present invention relates to water dispensers and, more particularly, but not by way of limitation to a water dispenser that includes improved sanitation, efficiency, safety, and serviceability characteristics as well as improved storage capacity.

2. Description of the Related Art

Drinking water quality has long been a concern. This concern leads individuals and businesses to provide at least one water cooler supplied with drinking water from a bottle, which typically is a five-gallon plastic bottle. A bottle is inverted over the water cooler and placed thereon so that drinking water fills a reservoir of the water cooler. In addition, certain water coolers include a cooling coil wrapped around the reservoir to cool the drinking water contained in the reservoir. The reservoir connects to a dispensing valve so that, upon operation of the dispensing valve, drinking water is delivered from the reservoir through the dispensing valve and to a suitable container held underneath the dispensing valve.

While existing water coolers function adequately to deliver drinking water, such water coolers do suffer from certain disadvantages. Illustratively, the reservoir of a water cooler is exposed to ambient air, resulting in the growth of bacteria within the reservoir. Although not normally harmful, such bacteria do create odor and taste problems in the drinking water. Accordingly, water coolers must be periodically cleaned which requires the transport of a water cooler to a cleaning facility. This is expensive as well as detrimental to the useful life of a water cooler. There are portable cleaning devices, however, such devices are intrusive and of questionable effectiveness.

Furthermore, drinking water bottles are subject to stress fractures that occur during the manufacturing process or through rough handling during delivery. While these stress fractures do not permit drinking water leakage, they do allow entrance of ambient air into a bottle, resulting in a condition where the air forces all the drinking water from the bottle when the bottle is inverted over and resting on a water cooler. As the capacity of water cooler reservoirs is less than the capacity of a bottle, the excess drinking water spills from the reservoir onto the area surrounding the water cooler, thereby creating a costly clean-up and repair situation for the water cooler supplier. In addition, the cooling capacity of a water cooler is limited due to the design whereby a cooling coil is wrapped around the water cooler reservoir.

Accordingly, there is a long felt need for a water dispenser that overcomes the aforementioned disadvantages in existing water coolers.

### SUMMARY OF THE INVENTION

In accordance with the present invention, a water dispenser delivers water from a water container disposed on a housing of the water dispenser. A removable and disposable reservoir is disposed within the housing and connects to a dispense valve mounted on the housing. The reservoir receives water from the water container and delivers the water to the dispense valve for dispensing from the water dispenser.

The reservoir includes a water fitment connectable to the dispense valve and an overflow fitment connectable to an overflow reservoir. The overflow reservoir is disposed in the housing and connects to the reservoir to receive excess water from the reservoir.

The housing includes a frame with a reservoir cavity that receives the reservoir therein and a cover that secures the reservoir within the frame. The frame includes an internal air gap that provides insulation characteristics. The housing further includes a base unit that supports the frame and an outer shell that surrounds the frame and the base unit.

A cold plate unit is disposed within the housing and contacts the reservoir to provide heat exchange therebetween. The cold plate unit includes a cold plate and an evaporator disposed in the cold plate. The cold plate resides in a pan supported by the base unit. The cold plate unit further includes a refrigeration unit disposed in and protected by the base unit.

It is therefore an object of the present invention to provide a water dispenser including a reservoir that is removable and disposable.

It is another object of the present invention to provide a water dispenser including a cold plate unit that contacts the reservoir to provide heat exchange therebetween.

It is a further object of the present invention to provide a water dispenser including an overflow reservoir that connects to the reservoir to receive excess water therefrom.

It is still a further object of the present invention to provide a water dispenser including a frame with an internal air gap that provides insulation characteristics.

It is still another object of the present invention to provide a water dispenser including a base unit that protects components of the cold plate unit.

Still other objects, features, and advantages of the present invention will become evident to those of ordinary skill in the art in light of the following.

### BRIEF DESRIPTION OF THE DRAWINGS

FIG. 1 is a perspective view illustrating a water dispenser according to the preferred embodiment.

FIG. 2 is an exploded perspective view illustrating the water dispenser according to the preferred embodiment.

FIG. 3 is a perspective view illustrating the water dispenser according to the preferred embodiment with an outer wall structure removed.

FIG. 4 is an exploded perspective view illustrating the water dispenser according to the preferred embodiment.

FIG. 5 is a perspective view illustrating a base unit of the water dispenser according to the preferred embodiment.

FIG. 6 is a perspective view illustrating a storage unit of the water dispenser according to the preferred embodiment.

FIG. 7 is a flowchart for the method of dispensing a drink from the water dispenser.

FIG. 7a is a flowchart for the method of changing the reservoir in the water dispenser.

### DETAILED DESCRIPTION OF THE PREFERRED EMBODIMENT

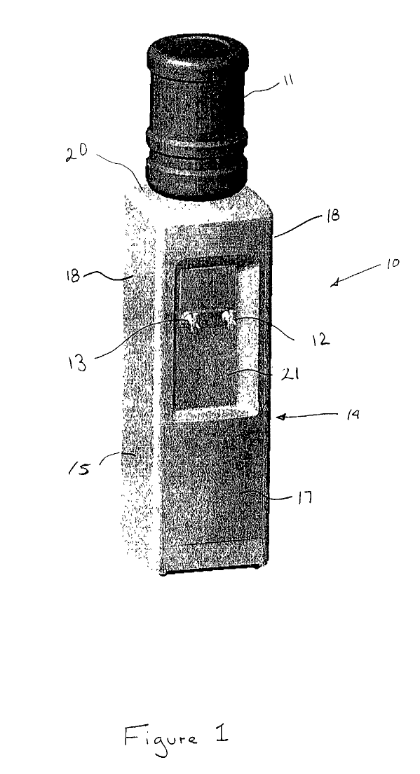

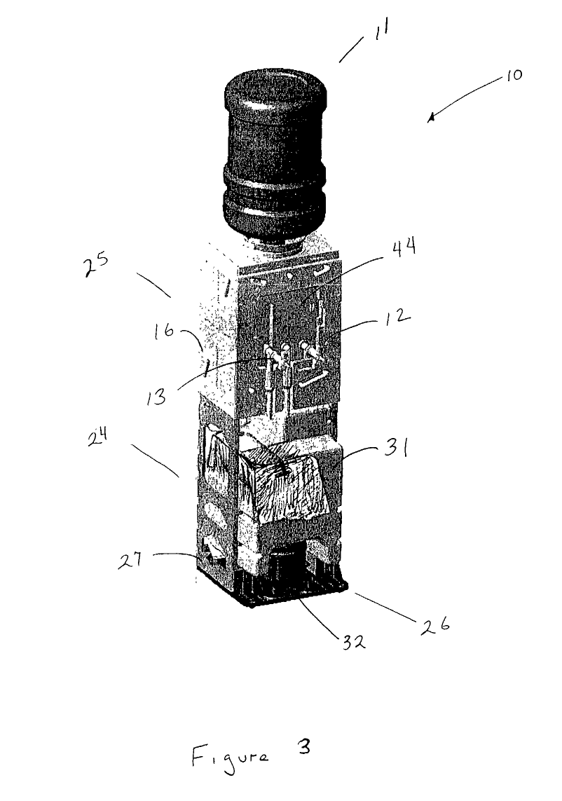

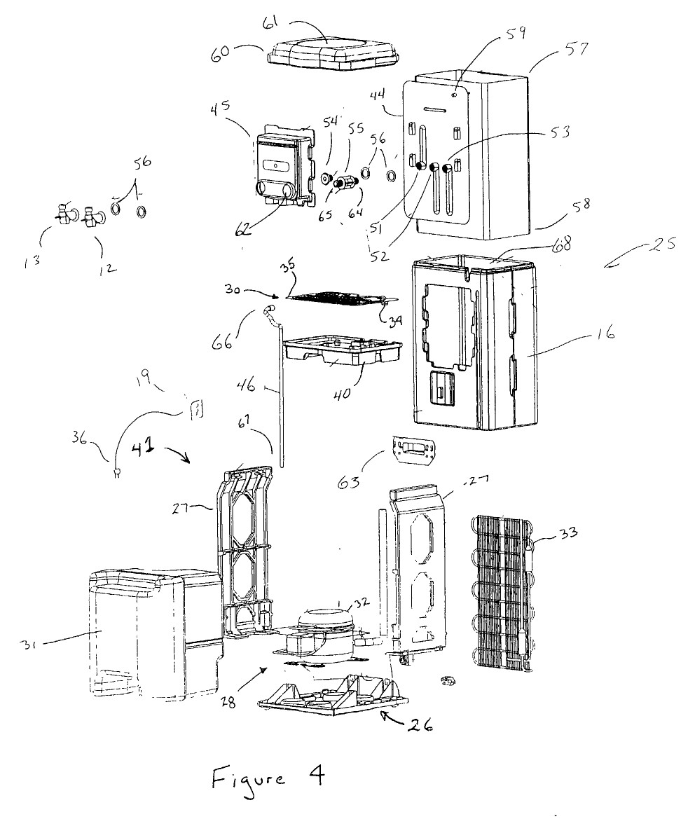

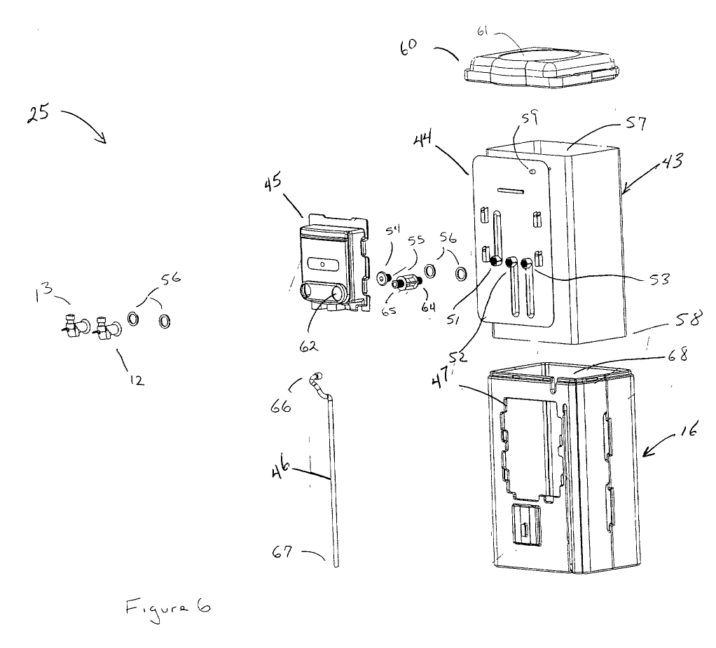

As illustrated in FIGS. 1-6, a water dispenser 10 delivers water from a water container 11 through a dispensing valve 12, which, in this preferred embodiment, delivers chilled water. Although the water dispenser 10 of this preferred embodiment does not dispense heated water, the water dispenser 10 includes a dispensing valve 13 to permit the dispensing of heated water. Illustratively, the water dispenser 10 could include a water heating system disposed therein that receives water from the water container 11, heats the received water, and delivers the heated water to the dispensing valve 13 for dispensing.

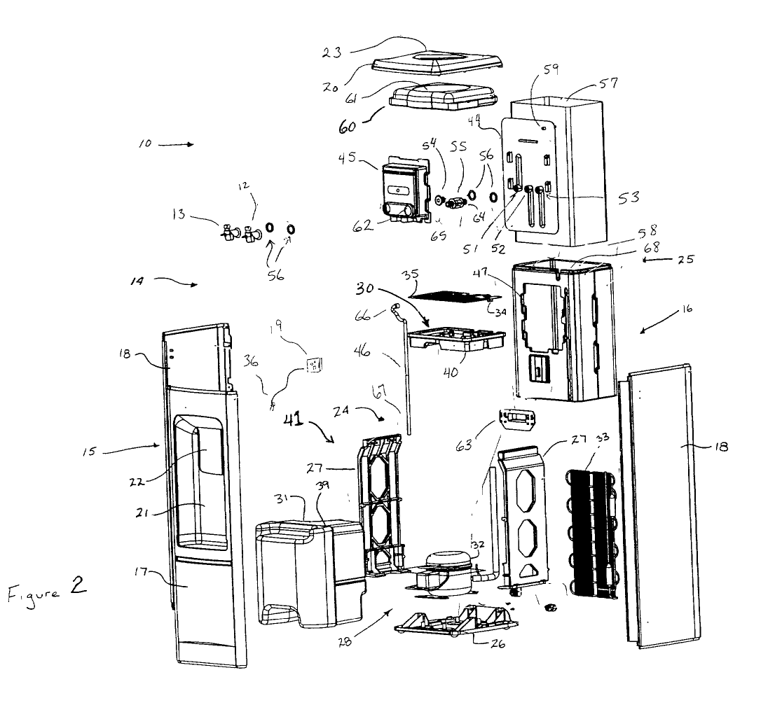

The water dispenser 10 includes a housing 14 that contains a shell 15, a base unit 24 and a storage unit 25 as shown in FIGS. 1-3. The shell 15 in this preferred embodiment includes a front member 17, side members 18, and a lid 20. The front member 17 includes an alcove 21 with an aperture 22 that receives therethrough the dispensing valves 12 and 13 to route the dispensing valves external to the housing 14 as shown in FIG. 2. The lid 20 supports the water container 11 and includes an aperture 23 that delivers water from the water container 11 into the water dispenser 10. The front member 17, the side members 18, and the lid 20 mount about the base unit 24 and the storage unit 25 and are secured together using any suitable fastening means, such as screws, to protect and support the interior components of the water dispenser 10.

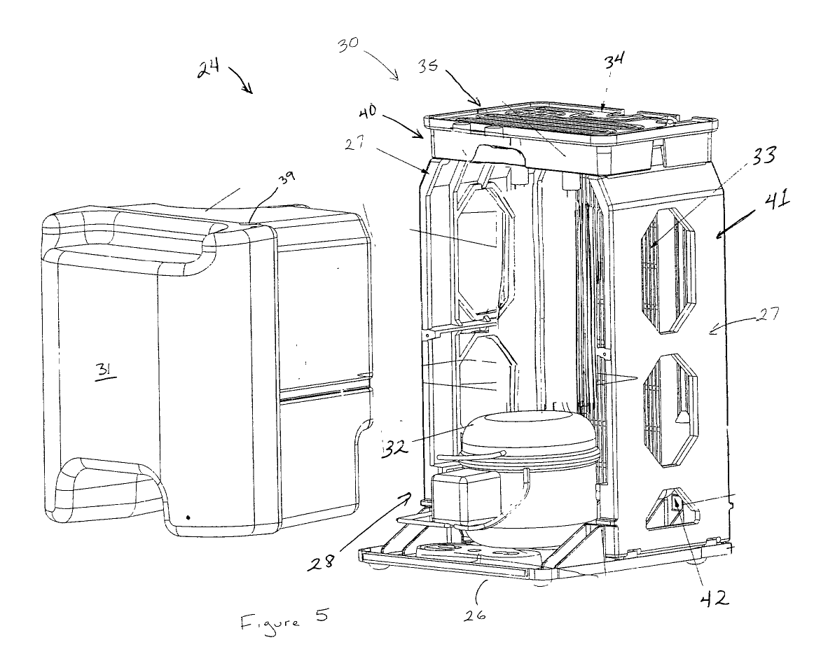

The base unit 24 includes a base unit frame assembly 41, a cold plate unit 30, and an overflow reservoir 31. The base unit frame assembly 41 includes a base 26, a handle 63 and two frame members 27. The base unit frame assembly 41 supports the storage unit 25 and the cold plate unit 30 as well as protects the cold plate unit 30 and the overflow reservoir 31 as shown in FIG. 5. The cold plate unit 30 includes a refrigeration unit 28, which in this preferred embodiment is of a type typically used in the industry. The refrigeration unit 28 is housed in the base unit frame assembly 41 and includes a compressor 32, a condenser 33, a capillary tube (in-line, not shown), a suitable drier (not shown) and an evaporator 34. The cold plate unit 30 further includes a cold plate 35 of thermally conductive material, such as aluminum, that encapsulates the evaporator 34. The cold plate 30 unit still further includes a pan 40 that supports the cold plate 35. The base unit frame assembly 41 in turn supports the pan 40. The overflow reservoir 31 also resides in the base unit frame assembly 41 as shown in FIG. 5. The overflow reservoir 31 has an inlet 39 for the intake of water and an alarm 19 to notify the user of water in the overflow reservoir 31. The alarm 19 consists of an electrode pair 36, an LED light, a high frequency sound emitter, and a battery powered printed circuit board to power the alarm 19 electronics.

The electrode pair 36 is suspended inside the overflow reservoir 31 at a prescribed height, approximately one-third capacity in this preferred embodiment. While the electrode pair 36 resides above the water level in the overflow reservoir 31, current does not flow between the electrodes because air does not conduct electricity. As the water level in the overflow reservoir 31 rises, the electrode pair 36 becomes immersed in the water resulting in current flow therebetween. The alarm 19 circuitry contained in the circuit board will detect this current flow and activate the alarm signals mentioned above.

The base unit 24 still further includes a power wire bundle (not shown) disposed on the base 26 that connects to a 110/115 VAC or other suitable standard outlet voltage via power receptacle 42 and an electrical cord. Upon connection to an outlet, the power wire bundle provides power to operate the refrigeration unit 28. A handle 63 is mounted to the rear of the base unit to aid in transport of the base unit 24, as well as the whole dispenser 10.

The storage unit 25 sits on top of the base unit 24 when installed. The storage unit 25 includes a frame 16, a removable reservoir 43, an interior cover 60, a fitment plate 44, a valve plate 45, and an overflow tube 46. The frame 16 is a single blow molded piece with ends that interlock to provide a rigid rectangular hollow section, the interior of which is known as a reservoir cavity 68. The use of blow-molding techniques provides an air gap in the frame 16 walls, which aids in thermal isolation. The frame 16 snaps into the pan 40 for additional rigidity. The reservoir 43 is a film bag having one open end 57 and one sealed end 58 with four fitments; one fitment 53 for chilled water to exit, one fitment 52 to supply a heater unit, one fitment 51 which is plugged, and one fitment 59 to attach to overflow tube 46. In use, the reservoir 43 is housed in the reservoir cavity 68, with the sealed end 58 nearest the bottom of dispenser 10. The open end 57 of the reservoir 43 is draped over the top end of frame 16, and the interior cover 60 is installed to keep the reservoir 43 in place. The interior cover 60 includes an aperture 61 that allows the water container 11 to deliver water into the reservoir 43. The reservoir fitments 51, 52 and 53 pass through an opening 47 in frame 16 and the fitment plate 44. The fitment plate 44 is a polyethylene sheet designed to keep fitments 51, 52, 53 and 59 on the flexible reservoir 43 in place. The prescribed hole pattern adapts to all three possible dispenser configurations, thereby reducing cost and inventories.

In the preferred embodiment, the fitments 51 and 52 are not used, and are sealed with fitment plugs 54. The fitment 53 is used to dispense cold water, and is connectable to a first end 64 of valve extension 55. A second end 65 of the valve extension 55 is connectable to the dispensing valve 12. The second end 65 of the valve extension 55 also passes through an aperture 62 in the valve plate 45 to gain access to the exterior of the housing 14. The valve plate 45 is a formed plastic mounting plate for the dispensing valve 12, and if outfitted, the dispensing valve 13. Gaskets 56 are used to provide seals between the valve extension 55 and the mating components. The overflow tube 46, having a fitting end 66 and a tubing end 67, connects the overflow fitment 59 of the reservoir 43 to the inlet 39 of the overflow reservoir 31 to provide a containment path for unexpected drainage from the water container 11. In this case, the fitting end 66 connects to the fitment 59, and the tubing end 67 is placed inside the inlet 39 of the overflow reservoir 31.

In operation, the refrigeration unit 28 provides cooling to the cold plate 35. This is accomplished by compressing the freon in the refrigeration system and then metering it to drop the pressure. When the pressure of the freon drops, the temperature of the freon also drops, bringing the evaporator 33 temperature, under normal conditions, down into approximately the twenty to thirty degree Fahrenheit range. With the evaporator 33 encapsulated in the cold plate 35, the system attempts to equalize, thereby cooling the cold plate 35 and thus the water in the reservoir 43, the bottom of which resides on the cold plate 35.

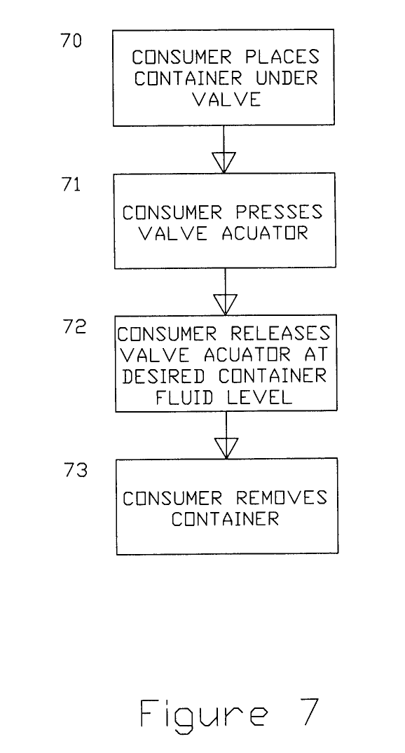

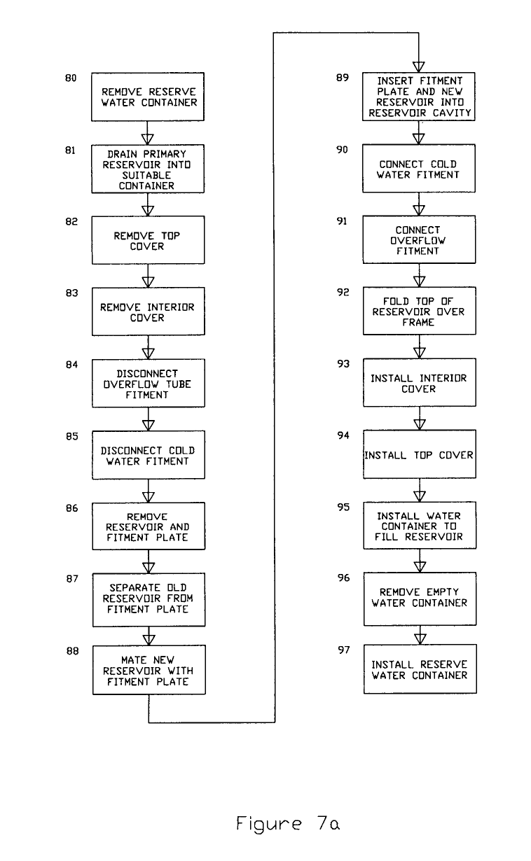

In operation, water is stored in the reservoir 43 and the water container 11. As the water in the reservoir 43 is used, water from the water container 11 replenishes it, passing through the aperture 23 in lid 20 and the aperture 61 in the interior cover 60. Upon a dispense, chilled water will pass from reservoir 43 through fitment 53, through valve extension 55 and through dispense valve 12. For the consumer, the method flowchart in FIG. 7 shows the process for dispensing a drink. Firstly, the consumer must place a suitable container under the dispensing valve 12 as shown in step 70. Next, the consumer presses the valve actuator as shown in step 71. Upon filling the container to the desired level, the consumer must release the valve actuator to stop the flow of water as shown in step 72. Finally, the consumer can remove the container from underneath the dispensing valve 12 as listed in step 73. The water dispenser 10 has a capacity of ten gallons, five of which are chilled in the reservoir 43.

In this preferred embodiment, the removable reservoir 43, the interior cover 60, and the water container 11 are the only water contact components. The reservoir 43 is a disposable, sanitized plastic film container with an open end 57 for receiving water. Disposable, in this preferred embodiment, is defined as being of a consumable nature, whereby it is more cost-effective to dispose of the reservoir 43 and replace with a new one, than it is to sanitize and reuse the reservoir 43. The reservoir 43 rests on the cold plate 35 of the cold plate unit 30, thereby providing cooling for the five gallons of water in the reservoir 43. The five-gallon capacity of the reservoir 43 provides the water dispenser 10 with a greater reservoir capacity than water dispensers typically available on the market. Most existing water dispensers choose to utilize small reservoirs to speed up cooling of the water in the reservoirs. The five-gallon capacity of the bag 43 in this preferred embodiment allows for the emptying of one complete five-gallon water container 11 into the reservoir 43 with an additional water container 11 installed on top of the water dispenser 10, thereby providing customers with ten gallons of water between deliveries. In most cases, the larger reservoir 43 will eliminate changing of water containers 11 by the customer, as the delivery personnel will be able to change out the water containers 11 as part of their normal delivery routine, as well as provide a greater number of servings.

In this preferred embodiment, the primary reservoir 43 rests on the cold plate 35 of the cold plate unit 30 with a contact area of over seventy square inches. This design allows for a greater amount of heat transfer from the water to the cold plate 35 due to the large contact area and very thin wall thickness of the reservoir 43. The cold plate 35 is virtually sealed from the atmosphere during operation to ensure that all heat transfer must be conducted to the water in the reservoir 43, and the frame 16 surrounding the reservoir 43 is a blow-molded part with a built in air gap. This gap provides an excellent insulation characteristic for keeping the reservoir 43 cool. The pan 40 provides an air gap between the pan 40 and the cold plate 35 to prevent condensation and thermal loss. Other attributes of the cold plate 35 design and the larger reservoir 43 include a rapid recovery after a cold water dispense, because the replenishing portion of the water in the reservoir 43 will usually be much smaller than the quantity of water already in the reservoir 43 that has already been chilled. This alone should keep the impact to the overall temperature of the reservoir 43 water to a minimum, as well as lead to reduced compressor 32 run time and power consumption.

The removable reservoir 43 provides advantages over and above current dispenser technology, including in-place sanitizing, and minimal full dispenser handling. The ability to change a reservoir 43 on demand provides service agents with the ability to quickly sanitize a dispenser 10 on location. The process for changing of the reservoir 43, in this preferred embodiment, is shown in the method flowchart of FIG. 7a. In the process of changing the reservoir 43, the reserve water container 11 must first be removed as shown in step 80. With the water container 11 removed, the primary reservoir 43 must be drained, step 81. The top cover 20 is then removed, step 82, followed by the removal of the interior cover 60 as shown in step 83. There is now access to the reservoir 43 fitments, and the operator must now disconnect the overflow tube fitment 59, step 84, followed by the disconnecting of the cold water fitment 53, step 85. The old reservoir and fitment plate 44 are then removed, step 86, and then separated in step 87.

The new reservoir 43 can now be mated to the fitment plate 44 as shown in step 88, and the mated assembly is then inserted into the reservoir cavity 68 as shown in step 89. Steps 90 and 91 provide for connecting the cold water fitment 53 and the overflow tube fitment 59, respectively. Once the fitment connections have been made, the operator must fold the top of the reservoir 43 over the top edge of frame 16, step 92, and then install the interior cover 60, step 93, to hold the reservoir 43 in place. The top cover 20 can then be installed as shown in step 94, followed by the installation of a water container 11 to fill the reservoir 43, step 95. Once empty, the water container 11 is removed as shown in step 96, so the reserve water container 11 can be installed on the dispenser 10, step 97. Alternatively, in order to minimize “on site” time, a new fitment plate 44 with valve extensions 55 and valves 12, can be pre-assembled to a new reservoir 43 “off site” and furnished as a kit in a sealed bag. The old reservoir and attachments can then be returned to the “off site” location where the old reservoir is discarded and the remaining items can be sanitized for re-use.

The fact that this operation may be conducted on-site thereby reduces the number of dispensers that must be shipped to a bottling plant or other collection area for sanitizing. In reducing the necessity of transporting of full dispensers, many of the problems associated with transporting, cleaning, and storing full dispensers also are minimized or eliminated, and the dispensers are not subjected to the harsh treatment in transport. Should the full dispenser 10 require overall cleaning, the use of polypropylene provides the ability to commercially wash the frame 16.

In many instances, water dispensers are furnished free for a period of time to entice new customers. When the free period expires without a commitment for continuing service, the dispenser must normally be returned to the bottling plant for resanitization, even though there is no real need for extensive cosmetic cleaning. In the preferred embodiment, the ability of the delivery personnel to change reservoir 43 will allow cosmetically clean dispensers to be transported to another location for immediate use. In most cases, the dispensers 10 will never have to be sent to the bottling plant for cleansing.

In this preferred embodiment, the working parts of the dispenser 10 are contained entirely inside the injection molded base unit frame assembly 41, which is sufficiently rugged to survive normal ground shipping and handling. Further advantages include dimensional and weight conformance for standard economical shipping through one of the larger transport carriers. This design will therefore allow all warranty work to the sealed system to be handled at centralized facilities where factory-trained personnel can accomplish repairs.

The preferred embodiment is outfitted with an overflow reservoir 31 having a five-gallon capacity. Should a water container 11 on the preferred embodiment leak, the water will first fill the reservoir 43 and then flow through fitment 59, through overflow tube 46, and into overflow reservoir 31 where it will be contained. When a certain amount of water accumulates in the overflow reservoir 31, the alarm 19 will be activated, the LED light will light and the alarm 19 will sound in a prescribed routine, thirty seconds every three hundred seconds in this preferred embodiment, to alert the user to contact his bottled water company for a replacement water container 11. A service agent must then replace the water container 11. The service agent then has the option of partial disassembly to remove and empty the overflow reservoir 31 or alternatively, using a small pump to pump the water out of the overflow reservoir 31 through the access opening provided for that purpose. Neither case should require that the dispenser 10 be transported to the bottling plant service area. The five-gallon overflow reservoir 31 is sufficient to hold the entire contents of a leaking water container 11. This feature should eliminate the costly cleanup expenses currently incurred by bottled water companies for overflowing dispensers including carpet cleaning and repair of hardwood floors.

Although the present invention has been described in terms of the foregoing preferred embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

I claim:

1. A water dispenser, comprising:
a housing;
a dispense valve mounted to the housing; and
a removable reservoir disposed within the housing, whereby the removable reservoir is coupled to the dispense valve to deliver water thereto.

2. The water dispenser of claim 1, wherein the housing is adapted to support a water container.

3. The water dispenser of claim 2, wherein the removable reservoir is sized to accommodate all the water within the water container disposed on the housing.

4. The water dispenser of claim 2, wherein the water container communicates water into the removable reservoir.

5. The water dispenser of claim 1 wherein the removable reservoir is disposable.

6. The water dispenser of claim 1, wherein the removable reservoir includes a thin film construction.

7. The water dispenser of claim 1, wherein the removable reservoir includes a water fitment connectable to the dispense valve.

8. The water dispenser of claim 1, wherein the removable reservoir includes an overflow fitment connectable to an overflow reservoir.

9. The water dispenser of claim 1, wherein the housing comprises a frame adapted to house the removable reservoir.

10. The water dispenser of claim 9, wherein the removable reservoir resides in a reservoir cavity of the frame.

11. The water dispenser of claim 9, wherein the frame includes a hollow wall construction that provides insulation characteristics.

12. The water dispenser of claim 1, further comprising an overflow reservoir disposed in the housing, whereby the removable reservoir is coupled to the overflow reservoir to deliver excess water thereto.

13. The water dispenser of claim 12, wherein the overflow reservoir includes an overflow tube that connects to an overflow fitment of the removable reservoir.

14. The water dispenser of claim 9, wherein the housing includes a cover that secures the removable reservoir within the frame.

15. A water dispenser, comprising:
a housing;
a reservoir disposed within the housing; and
a cold plate unit disposed within the housing, whereby the cold plate unit contacts the reservoir to provide heat exchange therebetween.

16. The water dispenser of claim 15, wherein the cold plate unit comprises:
a cold plate; and
an evaporator disposed in the cold plate.

17. The water dispenser of claim 16, wherein the cold plate resides in a pan supported by the housing.

18. The water dispenser of claim 15, wherein the cold plate unit comprises a refrigeration unit disposed in the housing.

19. The water dispenser of claim 15, wherein the housing comprises:
a base unit; and
a refrigeration system disposed in the base unit, whereby the base unit protects components of the refrigeration unit.

20. The water dispenser of claim 15 wherein the reservoir is removable from the housing.

21. A water dispenser, comprising:
a housing;
overflow reservoir disposed in the housing; and
a reservoir within the housing, whereby the reservoir is coupled to the overflow reservoir to deliver excess water thereto.

22. The water dispenser of claim 21, wherein the housing is adapted to support a water container.

23. The water dispenser of claim 22, wherein the water container communicates water into the reservoir.

24. The water dispenser of claim 21 wherein the reservoir is disposable.

25. The water dispenser of claim 22, wherein the overflow reservoir is sized to accommodate all the water in the water container disposed on the housing.

26. The water dispenser of claim 21, wherein the overflow reservoir includes an overflow tube that connects to an overflow fitment of the removable reservoir.

27. A water dispenser, comprising;
a storage unit, comprising a frame with an internal air gap that provides insulation characteristics.

28. The water dispenser of claim 27, further comprising a base unit that supports the frame.

29. The water dispenser of claim 27, further comprising an outer shell.

30. The water dispenser of claim 27, wherein the storage unit comprises a removable reservoir housed within the frame.

31. The water dispenser of claim 30, wherein the removable reservoir is disposable.

32. The water dispenser of claim 30, wherein the storage unit further comprises a cover that secures the removable reservoir within the frame.
